(19) United States
(12) Patent Application Publication
(10) Pub. No.: US 2025/0226005 A1
(43) Pub. Date: Jul. 10, 2025

(54) METHOD FOR PRODUCING MAGNETIC DISK AND LUBRICANT SOLUTION

(71) Applicant: Moresco Corporation, Kobe-shi, Hyogo (JP)

(72) Inventor: Tsuyoshi SHIMIZU, Kobe-shi (JP)

(21) Appl. No.: 18/848,680

(22) PCT Filed: Mar. 9, 2023
(86) PCT No.: PCT/JP2023/009015

§ 371 Date: Sep. 19, 2024

(30) Foreign Application Priority Data
Mar. 25, 2022 (JP) 2022-050875

(51) Int. Cl. G11B 5/725; C10M 107/38; C10N 40/18; C10N 50/02

(52) U.S. Cl. CPC G11B 5/7257; C10M 107/38; C10M 2213/0606; C10N 2040/18; C10N 2050/02

(57) ABSTRACT

An object is to provide a method for producing a magnetic disk that employs a fluorine-based solvent which has a low global warming potential and in which solubility of a high-polarity perfluoropolyether compound is excellent. This object is achieved by a method for producing a magnetic disk, the method including the step of applying, to a magnetic disk substrate, a lubricant solution containing a lubricant and a hydrofluoroether having a 100-year global warming potential value of less than 1000 and having a structure represented by the following Formula (A):

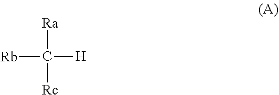

where: Ra represents F, CF₂-Re, or CF₃; Rb represents O-Rd or C(-Rf)₃; Rc represents H, F, or CF₃; Re and Rd each independently represent a hydrocarbon group which may be partially substituted by a fluorine atom and each have a main chain in which at least one carbon atom may be replaced by an oxygen atom; and Rfs each independently represent H, F, or a hydrocarbon group that may be partially substituted by a fluorine atom, and the hydrocarbon group that may be partially substituted by the fluorine atom has a main chain in which at least one carbon atom may be replaced by an oxygen atom.

### TECHNICAL FIELD

The present invention relates to: a method for producing a magnetic disk; and a lubricant solution.

### BACKGROUND ART

A magnetic disk in a magnetic recording and reproduction device generally has a base layer, a magnetic layer, a protective layer, and a lubricant layer which are formed in this order on a non-magnetic substrate. A method mainly used to form the lubricant layer is a dip method using a solution obtained by diluting a lubricant with a fluorine-based solvent. Further, in recent years, a high-polarity perfluoropolyether compound having a functional group such as a hydroxyl group, an aromatic ring, or a phosphazene at a terminal of a perfluoropolyether skeleton is likely to be used as the lubricant.

The solvent for diluting a lubricant needs to have a sufficient dissolution capacity for dissolving a lubricant, be liquid at room temperature, and be highly volatile for forming a uniform film. Further, it is desirable that the lubricant is flame-resistant, from the viewpoint of safety in a manufacturing process. Conventionally, Vertrel (registered trademark, Chemours-Mitsui Fluoroproducts Co., Ltd.) XF, which is a hydrofluorocarbon (HFC), Novec (registered trademark, 3M Company) 7100, which is a hydrofluoroether (HFE), and the like, are each used as a fluorine-based solvent for diluting a lubricant for a magnetic disk.

For example, Patent Literature 1 discloses: a lubricant application solution was prepared by dissolving, in Vertrel XF, a perfluoropolyether compound having a perfluorotrimethylene oxy-repeating unit in a main chain and a perfluoropolyether compound having a cyclic triphosphazene structure; and then, a magnetic disk substrate was immersed in the lubricant application solution, so that a lubricant layer was formed.

Patent Literature 2 discloses that a magnetic disk was immersed in a solution obtained by dissolving, in perfluorohexyl methyl ether (HFE-7100), a lubricant containing a phosphazene compound, so that a lubricant layer was formed.

Patent Literature 3 discloses that a perfluoropolyether-based lubricant having a cyclic triphosphazene-terminal group in a molecule was diluted with use of HFE-7100 as a solvent, and applied on a protective layer by a dip-coat method.

### CITATION LIST

### Patent Literature

### [Patent Literature 1]

Japanese Patent Application Publication Tokukai No. 2013-175279

### [Patent Literature 2]

International Publication No. WO 2001/21630

### [Patent Literature 3]

Japanese Patent Application Publication Tokukai No. 2000-260017

### SUMMARY OF INVENTION

### Technical Problem

However, a conventional fluorine-based solvent as described above had room for improvement in the following point: the conventional fluorine-based solvent has a high global warming potential (GWP) and therefore imposes a large environmental burden; or solubility of a high-polarity perfluoropolyether-based lubricant, which is likely to be used as a lubricant in recent years, in a solvent is insufficient.

An object of an aspect of the present invention is to provide: a method for producing a magnetic disk that employs a fluorine-based solvent which has a low global warming potential and in which solubility of a high-polarity perfluoropolyether-based lubricant is excellent, and a lubricant solution that employs the fluorine-based solvent.

### Solution to Problem

That is, embodiments of the present invention include the following configurations.

A method for producing a magnetic disk in accordance with an embodiment of the present invention is a method for producing a magnetic disk, the method including a lubricant application step of applying, to a surface of a magnetic disk, a lubricant solution containing a perfluoropolyether-based lubricant, the lubricant solution employing a solvent containing a hydrofluoroether (HFE) having a 100-year global warming potential (GWP) value of less than 1000 and having a structure represented by the following Formula (A):

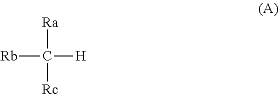

where: Ra represents F, CF₂-Re, or CF₃; Rb represents O-Rd or C(-Rf)₃; Rc represents H, F, or CF₃; Re and Rd each independently represent a hydrocarbon group which, optionally, is partially substituted by a fluorine atom and each have a main chain in which at least one carbon atom is optionally replaced by an oxygen atom; and Rfs each independently represent H, F, or a hydrocarbon group that, optionally, is partially substituted by a fluorine atom, and the hydrocarbon group that, optionally, is partially substituted by the fluorine atom has a main chain in which at least one carbon atom is optionally replaced by an oxygen atom.

A lubricant solution in accordance with an embodiment of the present invention is a lubricant solution including a perfluoropolyether-based lubricant, the lubricant solution employing a solvent containing a hydrofluoroether having a 100-year global warming potential value of less than 1000 and having a structure represented by the following Formula (A):

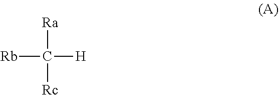

where: Ra represents F, CF₂-Re, or CF₃; Rb represents O-Rd or C(-Rf)₃; Rc represents H, F, or CF₃; Re and Rd each independently represent a hydrocarbon group which, optionally, is partially substituted by a fluorine atom and each have a main chain in which at least one carbon atom is optionally replaced by an oxygen atom; and Rfs each independently represent H, F, or a hydrocarbon group that, optionally, is partially substituted by a fluorine atom, and the hydrocarbon group that, optionally, is partially substituted by the fluorine atom has a main chain in which at least one carbon atom is optionally replaced by an oxygen atom.

### Advantageous Effects of Invention

An aspect of the present invention can provide: a method for producing a magnetic disk that employs a fluorine-based solvent which has a low global warming potential and in which solubility of a high-polarity perfluoropolyether-based lubricant is excellent; and a lubricant solution that employs the fluorine-based solvent.

### BRIEF DESCRIPTION OF DRAWINGS

FIG. 1 is a cross-sectional view illustrating a configuration of a magnetic disk in accordance with an embodiment of the present invention.

FIG. 2 is a cross-sectional view illustrating a configuration of a magnetic disk in accordance with an embodiment of the present invention.

### DESCRIPTION OF EMBODIMENTS

The following description will discuss embodiments of the present invention in detail. Note, however, that the present invention is not limited to the following embodiments but can be variously altered within this disclosure. The present invention also encompasses, in its technical scope, any embodiment derived by appropriately combining technical means disclosed in differing embodiments. Note that the expression “A to B” representing a numerical range herein means “A or more and B or less” unless otherwise specified in this specification.

### (1) Method for Producing Magnetic Disk

Conventionally, Vertrel (registered trademark, hereinafter, the same applies to “Vertrel” in the present specification) XF, which is a hydrofluorocarbon (hereinafter, in the present specification, also referred to as “HFC”) described earlier, Novec (registered trademark, hereinafter, the same applies to “Novec” in the present specification) 7100 (HFE-7100), which is a hydrofluoroether (hereinafter, in the present specification, also referred to as “HFE”), or the like has been used as a fluorine-based solvent to dissolves a lubricant for a magnetic disk. However, in the case of Vertrel XF, although solubility of a high-polarity perfluoropolyether-based lubricant is favorable, a global warming potential (hereinafter, in the present specification, also referred to as “GWP”) is high. Thus, Vertrel XF imposes a large burden on an environment. On the other hand, in the case of HFE, although the GWP is low, particularly the solubility of a high-polarity perfluoropolyether-based lubricant in the HFE is not sufficient. Therefore, in recent years, use of Vertrel XF may be the only way to dissolve a lubricant for a magnetic disk in the fluorine-based solvent.

For consideration of a solvent for a perfluoropolyether-based lubricant, the present inventor used one of HFEs which had been considered to be incapable of sufficiently dissolving, particularly, a high-polarity perfluoropolyether-based lubricant. As a result, surprisingly, the present inventor found that the HFE can dissolve a high-polarity perfluoropolyether-based lubricant. As a result of studies based on such finding, the present inventor has found that since in the case of an HFE having a specific structure in a molecule, the solubility of a high-polarity perfluoropolyether-based lubricant in the HFE is high and the GWP of the HFE is low, the HFE can be suitably used as a solvent for a perfluoropolyether-based lubricant. Consequently, the present inventor has accomplished the present invention.

That is, a method for producing a magnetic disk in accordance with an embodiment of the present invention is a method for producing a magnetic disk, the method including a lubricant application step of applying, to a surface of a magnetic disk, a lubricant solution containing a perfluoropolyether-based lubricant, the lubricant solution employing a solvent containing a HFE having a 100-year GWP value of less than 1000 and having a structure represented by the following Formula (A):

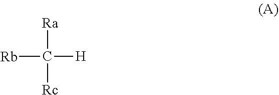

where: Ra represents F, CF₂-Re, or CF₃; Rb represents O-Rd or C(-Rf)₃; Rc represents H, F, or CF₃; Re and Rd each independently represent a hydrocarbon group which may be partially substituted by a fluorine atom and each have a main chain in which at least one carbon atom may be replaced by an oxygen atom; and Rfs each independently represent H, F, or a hydrocarbon group that may be partially substituted by a fluorine atom, and the hydrocarbon group that may be partially substituted by the fluorine atom has a main chain in which at least one carbon atom may be replaced by an oxygen atom.

### (1.1) Solvent Employed for Lubricant Solution

In an embodiment of the present invention, a solvent to be used for the lubricant solution contains an HFE having a 100-year GWP value of less than 1000 and having a structure represented by the above Formula (A). With the above configuration, it is possible to provide: a method for producing a magnetic disk that employs a fluorine-based solvent which has a low global warming potential and in which the solubility of a high-polarity perfluoropolyether-based lubricant is excellent; and a lubricant solution employing the fluorine-based solvent. Further, the solvent has excellent evaporability equivalent to that of Vertrel XF currently mainly used, and is capable of forming a uniform lubricant layer. Furthermore, the present inventor has found that the solvent having the above configuration makes it possible to yield an additional effect of improving adsorption properties of a lubricant layer with respect to a magnetic disk. In addition, the present inventor also has found that the solvent having the above configuration yields an effect that contact angles of water, n-hexadecane, and the like with respect to the lubricant layer are large and thus, surface energy of the lubricant layer is small. A lubricant layer having large contact angles of water, n-hexadecane and the like and having a small surface energy of the lubricant layer can advantageously prevent contamination of a surface of the magnetic disk.

The HFE here is a compound that includes an ether structure which has been partially substituted by a fluorine atom and which has a hydrogen atom. The HFE only needs to have a structure represented by the following Formula (A):

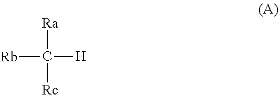

where: Ra represents F, CF₂-Re, or CF₃; Rb represents O-Rd or C(-Rf)₃; Rc represents H, F, or CF₃; Re and Rd each independently represent a hydrocarbon group which may be partially substituted by a fluorine atom and each have a main chain in which at least one carbon atom may be replaced by an oxygen atom; and Rfs each independently represent H, F, or a hydrocarbon group that may be partially substituted by a fluorine atom, and the hydrocarbon group that may be partially substituted by the fluorine atom has a main chain in which at least one carbon atom may be replaced by an oxygen atom.

An HFE having the structure represented by General Formula (A) in a molecule can dissolve a high-polarity perfluoropolyether-based lubricant. The reason for this is inferred as follows: a hydrogen atom bonded to a carbon atom that binds to Ra, Rb, and Rc in General Formula (A) is biased toward a positive charge by being surrounded by Ra, Rb, and Rc which can contain many fluorine atoms; and Consequently, the hydrogen atom forms a hydrogen bond with a polar group of the high-polarity perfluoropolyether-based lubricant, so that affinity of the lubricant with the HFE is improved.

The HFE is not particularly limited, provided that the HFE has the above structure. Examples of the HFE include Rd-O—CH₂F, Rd-O—CHF₂, Rd-O—CHFCF₃, Rd-O—CH₂CF₂-Re, Rd-O—CHFCF₂-Re, Rd-O—CH(CF₃)CF₂-Re, Rd-O—CH₂CF₃, Rd-O—CH(CF₃)₂, C(-Rf)₃-CH₂F, C(-Rf)₃-CHF₂, C(-Rf)₃-CHFCF₃, C(-Rf)₃-CH₂CF₂-Re, C(-Rf)₃-CHFCF₂-Re, C(-Rf)₃-CH(CF₃)CF₂-Re, C(-Rf)₃—CH₂CF₃, and C(-Rf)₃-CH(CF₃)₂.

Re and Rd here each independently represent a hydrocarbon group that may be partially substituted by a fluorine atom and that has 1 to 10 carbon atoms, more preferably 1 to 5 carbon atoms, and even more preferably 1 to 3 carbon atoms. At least one carbon atom in a main chain may be replaced by an oxygen atom. Note here that in a case where at least one carbon atom in a main chain is replaced by an oxygen atom, the oxygen atom which has replaced the carbon atom is also regarded as a carbon atom and is counted in the number of carbon atoms in the hydrocarbon group (the same applies to Rfs below).

The Rfs each independently represent H, F, or a hydrocarbon group that may be partially substituted by a fluorine atom, and the hydrocarbon group that may be partially substituted by a fluorine atom has a main chain in which at least one carbon atom may be replaced by an oxygen atom. In another embodiment, at least one of Rfs is a hydrocarbon group that may be partially substituted by a fluorine atom, and at least one carbon atom in a main chain may be replaced by an oxygen atom.

Further, the Rfs each independently represent H, F, or a hydrocarbon group that may be partially substituted by a fluorine atom and that has 1 to 10 carbon atoms, more preferably 1 to 5 carbon atoms, and even more preferably 1 to 3 carbon atoms, and the hydrocarbon group that may be partially substituted by a fluorine atom has a main chain in which at least one carbon atom may be replaced by an oxygen atom. In another embodiment, at least one of the Rfs is a hydrocarbon group that may be partially substituted by a fluorine atom and that has 1 to 10 carbon atoms, more preferably 1 to 5 carbon atoms, and even more preferably 1 to 3 carbon atoms, and at least one carbon atom in a main chain may be replaced by an oxygen atom. Among others, it is more preferable that one of the Rfs be the hydrocarbon group which may be partially substituted by a fluorine atom and in which at least one carbon atom in a main chain may be replaced by an oxygen atom, and the other two of the Rfs are each independently H or F. The above-described HFEs can be each used alone, and two or more of the HFEs can be used in combination.

Specific examples of the HFE include: 1,1,2,2-tetrafluoroethyl 2,2,2-trifluoroethyl ether, 1,1,2,3,3,3-hexafluoropropyl methyl ether, 1,1,1,3,3,3-hexafluoro-2-methoxypropane (hexafluoroisopropyl methyl ether), methyl 2,2,3,3,3-pentafluoropropyl ether, ethyl 1,1,2,2-tetrafluoroethyl ether, and ethyl 1,1,2,3,3,3-hexafluoropropyl ether.

In the present embodiment, the HFE is a compound having a 100-year GWP value of less than 1000. In the present specification, the term “GWP” refers to a GWP according to the IPCC Fifth Assessment Report. The “GWP” is a value obtained by estimating, as a ratio relative to carbon dioxide, an accumulated value of radiant energy applied to the earth within a certain period of time (e.g., 100 years) in a case where a unit mass (e.g., 1 kg) of a greenhouse gas is released into the atmosphere. Thus, the greater the value of the GWP, the greater a negative impact on global warming; the smaller the value of GWP, the smaller a negative impact on global warming. The values of the GWP based on differing time scales (i.e., 20 years, 100 years, and 500 years) are published; however, in general, the 100-year GWP value is used.

In the present embodiment, the 100-year GWP value of the HFE is preferably less than 1000, more preferably less than 900, more preferably less than 800, even more preferably less than 700, and most preferably less than 600.

The boiling point of the HFE is preferably 30° C. to 100° C., more preferably 35° C. to 90° C., and even more preferably 40° C. to 80° C. In a case where the boiling point of the HFE is 100° C. or less, drying properties of the solvent after application to the disk is excellent. Therefore, the boiling point of 100° C. or less is preferable. Further, in a case where the boiling point of the HFE is 30° C. or more, less significant concentration change of the solution containing the lubricant occurs due to evaporation of the solvent. Therefore, a boiling point of 30° C. or more is preferable.

The HFE is preferably flame-resistant from the viewpoint of safety in the manufacturing process. In the present specification, the term “flame-resistant” is a reference based on JIS K2265.

The HFE more preferably has three or more carbon-hydrogen bonds. Since with this configuration, the HFE is liquid at normal temperature, the HFE is suitable for the dip method, and in addition, the 100-year global warming potential is likely to be low.

In an embodiment of the present invention, the solvent employed for the lubricant solution only needs to include the HFE, but can include another solvent(s) to an extent that does not have an undesirable effect on the effect of the present invention. As for the other solvent(s), for example, an organic solvent that does not contain a fluorine atom can be used. Examples of the organic solvent that does not contain a fluorine atom include: alcohols such as methanol, ethanol, N-propyl alcohol, isopropyl alcohol, t-butanol, and n-butanol; ketones; ethers; dimethyl sulfoxide; and dimethyl formamide. Alternatively, even in a case where the HFC is included, the GWP can be reduced overall according to an embodiment of the present invention. The content of the other solvent(s) is preferably 30 weight percent or less, more preferably 20 weight percent or less, and even more preferably 10 weight percent or less, and particularly preferably 5 weight percent or less, relative to the total amount of the solvent. However, the content is not limited thereto.

### (1.2) Perfluoropolyether-Based Lubricant

In an embodiment of a present invention, the perfluoropolyether-based lubricant to be used as the lubricant preferably contains a perfluoropolyether compound having a structure represented by the following Formula (1):

—(CF₂)ₓ(CF(CF₃))_{y}O(CF₂O)_{z}(CF₂CF₂O)ₗ(CF₂CF₂CF₂O)ₘ(CF₂CF₂CF₂CF₂O)ₙ(CF(CF₃)CF₂O)ₒ—(CF(CF₃))_{y}(CF₂)ₓ— (1)
where x is a real number of 0 to 3, y is a real number of 0 to 1, and z, l, m, n, and o are each a real number of 0 to 15 and further, either x or y is a real number of 1 or more and at least any one of z, l, m, n, and o is a real number of 1 or more.

Examples of the above-described Formula (1) includes Demnum skeleton: —CF₂CF₂O—(CF₂CF₂CF₂O)ₘCF₂CF₂—, Fomblin skeleton: —CF₂O—(CF₂O)_{z}(CF₂CF₂O)ₗCF₂—, C2 skeleton: —CF₂O—(CF₂CF₂O)ₗCF₂—, C4 skeleton: —CF₂CF₂CF₂O—(CF₂CF₂CF₂CF₂O)ₙCF₂CF₂CF₂—, and Krytox skeleton: CF(CF₃)O—(CF(CF₃)CF₂O)ₒCF(CF₃)—. In the skeleton, z, l, m, n, and o are each a real number of 1 to 15. Note that in the Fomblin skeleton, CF₂O and CF₂CF₂O can be randomly repeated.

The perfluoropolyether compound preferably has, in a molecule thereof, at least one structure represented by Formula (1). That is, the perfluoropolyether compound may have, in a molecule thereof, two or more structures each represented by Formula (1). In this case, the two or more structures each represented by Formula (1) may be bonded via any organic group. Examples of the organic group include an aliphatic hydrocarbon group and an aromatic hydrocarbon group. The aliphatic hydrocarbon group and the aromatic hydrocarbon group each may include an ether bond and/or a hydroxyl group.

For example, the perfluoropolyether compound is represented by the following Formula (2):

R¹—R²—R³ (2),
where R² represents an organic group having perfluoropolyether skeleton. R² is, for example, a perfluoropolyether skeleton represented by Formula (1) above, and two or more structures represented by Formula (1) may be bonded via any organic group as described above.

R¹ and R³ are each independently an organic group having a fluorine atom, a hydroxyl group, an alkyl halide group, an alkoxy group, a carboxyl group, an amino group, an ester group, an amide group, an aryl group, or a phosphazene at a terminal thereof. For example, R¹ and R³ are each independently —F, —CH₂OH, —CH₂OCH₂CH(OH)CH₂OH, —CH₂OCH₂CH(OH)CH₂OCH₂CH(OH)CH₂OH, —CH₂O(CH₂)_{g}OH, —CH₂OCH₂CH(OH)CH₂OC₁₂H₉O, —CH₂OCH₂CH(OH)CH₂OC₁₀H₇, or CH₂OCH₂CH(OH)CH₂OC₆H₄—R⁴. Here, g is a real number of 1 to 10, and R⁴ can be, for example, a hydrogen atom, a hydroxyl group, an alkoxy group having 1 to 4 carbon atoms, an amino group, and an amide residue. R⁴ is preferably a hydroxyl group or an alkoxy group.

Examples of the perfluoropolyether compound in which two or more perfluoropolyether skeletons are bonded to each other via any organic group include a compound represented by the following Formula (4):

R¹—R⁵—R⁶—R⁷—R³ (4).

R⁵ and R⁷ are each an organic group having a perfluoropolyether skeleton, and are each for example, a perfluoropolyether skeleton represented by the above-described Formula (1).

R⁶ is any organic group, and is, for example, an aliphatic hydrocarbon group or an aromatic hydrocarbon group. The aliphatic hydrocarbon group and the aromatic hydrocarbon group each may include an ether bond and/or a hydroxyl group.

R¹ and R³ are organic groups similar to that represented by Formula (2).

The number average molecular weight of the perfluoropolyether compound is not limited but is preferably 500 to 6000, and more preferably 700 to 4000. Further, the number of hydroxyl groups per molecule of the perfluoropolyether compound is not limited but is preferably 1 to 10, more preferably 2 to 8, and even more preferably 4 to 8. In this specification, the number average molecular weight of the perfluoropolyether compound is a value as measured by ¹⁹F-NMR with the use of JNM-ECX400 available from JEOL Ltd. In the measurement by the NMR, a sample is not diluted with a solvent, but is directly used. A known peak corresponding to a part of the skeleton structure of the perfluoropolyether compound serves to substitute for the reference for a chemical shift.

The perfluoropolyether compound may be a perfluoropolyether compound that satisfies the following Formula (3):

$${N}_{O H} / ( Mn / 1500 ) \geq 2 \qquad ( 3 )$$

where N_{OH} represents the number of hydroxyl groups per molecule of the perfluoropolyether compound and Mn represents a number average molecular weight of the perfluoropolyether compound.

The solvent described in the above section (1.1) can be suitably used for any perfluoropolyether-based lubricant. The solvent can be suitably used particularly for a high-polarity perfluoropolyether compound that satisfies, for example, Formula (3). In general, the solubility of the high-polarity perfluoropolyether compound that satisfies, for example, Formula (3) in HFE is low. However, since this compound dissolves well in the solvent described in above section (1.1), the solvent described in the above section (1.1) is highly effective.

In an embodiment of the present invention, the above-described perfluoropolyethers compound may be each used alone, and two or more thereof may be used in combination.

### (1.3) Lubricant Application Step

A method for producing a magnetic disk in accordance with an embodiment of the present invention includes a lubricant application step of applying, to a surface of a magnetic disk, a lubricant solution containing the above-described perfluoropolyether-based lubricant, the lubricant solution employing the above-described solvent as a solvent. The lubricant solution here only needs to be a solution obtained by dissolving the above-described perfluoropolyether-based lubricant in the above-described solvent. The lubricant solution can be used as a lubricant for recording media, in order to improve the sliding properties of magnetic disks.

The concentration of the perfluoropolyether-based lubricant in the lubricant solution is preferably 0.001% by weight to 1.0% by weight, more preferably 0.003% by weight to 0.5% by weight, and even more preferably 0.005% by weight to 0.3% by weight. In a case where the concentration of the perfluoropolyether-based lubricant is 0.001% by weight or more, it is possible to cover a disk with perfluoropolyether and inactivate the surface of the disk and to ensure the sliding properties. Thus, a concentration of 0.001% by weight or more is preferable. On the other hand, a concentration of 1.0% by weight or less causes an applied film to be thin, and is thus preferable.

The lubricant solution only need to include the perfluoropolyether-based lubricant and the solvent. The lubricant solution more consists preferably of the perfluoropolyether-based lubricant and the solvent, but may include another component(s). Examples of the other component(s) include a lubricant other than the perfluoropolyether-based lubricant, such as a hydrocarbon-based lubricant and a fatty acid ester-based lubricant. The content of the other component(s) is, for example, 10% by weight or less relative to the total weight of the lubricant solution.

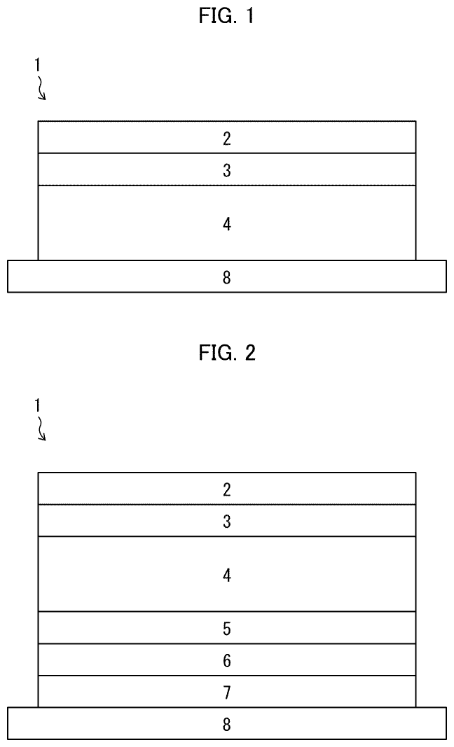

In the present step, the lubricant solution is applied to a surface of a magnetic disk. The magnetic disk here includes, like a magnetic disk 1 illustrated in FIG. 1, a recording layer 4, a protective layer 3, and a lubricant layer 2, which are placed on a non-magnetic substrate 8. The lubricant layer 2 includes the lubricant described earlier.

Alternatively, the magnetic disk can include, like a magnetic disk 1 illustrated in FIG. 2, a lower layer 5 that underlies a recording layer 4, one or more soft magnetic lower layers 6 that underlie the lower layer 5, and an adhesive layer 7 that underlies the one or more soft magnetic lower layers 6.

In the present step, a lubricant layer is formed by applying the lubricant solution to a surface of a protective layer of a magnetic disk in which at least a recording layer and the protective layer are formed on a non-magnetic substrate.

In the present step, examples of a method of applying the lubricant solution to the surface of the magnetic disk include, but are not limited to, a dip method, a spin coating method, a spray method, and a paper coating method. Among others, the dip method is more preferable.

The temperature of the lubricant solution when the lubricant solution is applied to a surface of a magnetic disk is not particularly limited. In order to apply the lubricant solution so that the film thickness of the lubricant can be uniform, it is preferable that the temperature of the lubricant solution at the time of application be between 10° C. and 40° C. from the viewpoint of minimizing a change in concentration of the lubricant solution.

Further, after application of the lubricant solution to the surface of the protective layer, ultraviolet irradiation or heat treatment may be carried out. The ultraviolet irradiation or heat treatment can form a stronger bond between the lubricant layer and the protective layer and therefore prevents the lubricant from evaporating due to heating. In ultraviolet irradiation, ultraviolet light having a dominant wavelength of 185 nm or 254 nm is preferably used, in order to activate an interface between the lubricant and the protective layer without affecting the lubricant layer and a deep area of the protective layer. The temperature for heat treatment is preferably 60° C. to 170° C., more preferably 80° C. to 170° C., and even more preferably 80° C. to 150° C.

In the dip method, for example, a magnetic disk is immersed in the lubricant solution and pulled up from the lubricant solution, so that the lubricant solution can be applied to the surface of the magnetic disk. In this case, a time period for immersing the magnetic disk is not particularly limited. The time period is, for example, 1 minute to 10 minutes. Further, the rate of pulling up the magnetic disk after immersion is also not particularly limited. The rate is, for example, 0.5 mm/sec to 5 mm/sec.

### (1.4) Other Steps

The method for producing a magnetic disk according to an embodiment of the present invention may further include: a step of producing the perfluoropolyether-based lubricant; a step of preparing the lubricant solution; a step of forming the recording layer on the non-magnetic substrate, a step of forming the protective layer on the recording layer, and the like.

Each of the layers of the magnetic disk other than the lubricant layer can contain a material that is known in this technical field to be suitable for a corresponding layer of a magnetic disk. Examples of the material of the recording layer include: an alloy of an element (e.g., iron, cobalt, and nickel) from which a ferromagnetic material can be formed and chromium, platinum, tantalum or the like; and an oxide of the alloy. Examples of the material of the protective layer include carbon, Si₃N₄, SiC, and SiO₂. Examples of the material of the non-magnetic substrate include an aluminum alloy, glass, and polycarbonate.

A method of preparing the lubricant solution is also not particularly limited. For example, the lubricant solution can be prepared by dissolving the perfluoropolyether-based lubricant described earlier in the solvent. Further, the HFE used for the solvent can be manufactured by a conventionally well-known method or can be a commercial product. A method of producing the perfluoropolyether-based lubricant is also not particularly limited. The perfluoropolyether-based lubricant can be prepared by selecting, as appropriate, a conventionally well-known method.

### (2) Lubricant Solution

An embodiment of the present invention includes a lubricant solution that includes a perfluoropolyether-based lubricant, the lubricant solution employing a solvent containing an HFE having a 100-year GWP value of less than 1000 and having a structure represented by the following Formula (A):

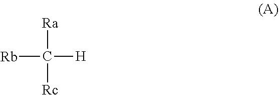

where: Ra represents F, CF₂-Re, or CF₃; Rb represents O-Rd or C(-Rf)₃; Rc represents H, F, or CF₃; Re and Rd each independently represent a hydrocarbon group which may be partially substituted by a fluorine atom and each have a main chain in which at least one carbon atom may be replaced by an oxygen atom; and Rfs each independently represent H, F, or a hydrocarbon group which may be partially substituted by a fluorine atom and each have a main chain in which at least one carbon atom may be replaced by an oxygen atom.

The perfluoropolyether-based lubricant, the solvent and the lubricant solution are as described in that above section (1).

The lubricant solution can be used as a lubricant for recording media, in order to improve the sliding properties of magnetic disks. The lubricant solution can also be used as a lubricant for recording media in other recording devices that involve sliding between a recording head and a recording medium (e.g., a magnetic tape) other than a magnetic disk. The lubricant solution can also be used as a lubricant for devices other than the recording devices that include a part involving sliding.

The present invention is not limited to the embodiments described above but can be variously altered within the scope of claims. The present invention also encompasses, in its technical scope, any embodiment derived by appropriately combining technical means disclosed in differing embodiments.

Aspects of the present invention can also be expressed as follows.

Embodiments of the present invention include the following configurations.

(1) A method for producing a magnetic disk, the method including a lubricant application step of applying, to a surface of a magnetic disk, a lubricant solution containing a perfluoropolyether-based lubricant, the lubricant solution employing a solvent containing a hydrofluoroether having a 100-year global warming potential value of less than 1000 and having a structure represented by the following Formula (A):

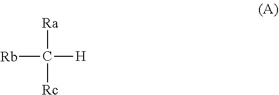

where: Ra represents F, CF₂-Re, or CF₃; Rb represents O-Rd or C(-Rf)₃; Rc represents H, F, or CF₃; Re and Rd each independently represent a hydrocarbon group which, optionally, is partially substituted by a fluorine atom and each have a main chain in which at least one carbon atom is optionally replaced by an oxygen atom; and Rfs each independently represent H, F, or a hydrocarbon group that, optionally, is partially substituted by a fluorine atom, and the hydrocarbon group that, optionally, is partially substituted by the fluorine atom has a main chain in which at least one carbon atom is optionally replaced by an oxygen atom.

(2) The method according to (1), wherein the solvent has a boiling point of 30° C. to 100° C. and is flame-resistant.

(3) The method according to (1) or (2), wherein the hydrofluoroether has three or more carbon-hydrogen bonds.

(4) The method according to any one of (1) to (3), wherein the perfluoropolyether-based lubricant contains a perfluoropolyether compound having a structure represented by the following Formula (1):

—(CF₂)ₓ(CF(CF₃))_{y}O(CF₂O)_{z}(CF₂CF₂O)ₗ(CF₂CF₂CF₂O)ₘ(CF₂CF₂CF₂CF₂O)ₙ(CF(CF₃)CF₂O)ₒ—(CF(CF₃))_{y}(CF₂)ₓ— (1),
where x is a real number of 0 to 3, y is a real number of 0 to 1, and z, l, m, n, and o are each a real number of 0 to 15 and further, either x or y is a real number of 1 or more and at least any one of z, l, m, n, and o is a real number of 1 or more.

(5) The method according to (4), wherein the perfluoropolyether compound has a structure represented by the following Formula (2):

R¹—R²—R³ (2),
where: R² is an organic group having a perfluoropolyether skeleton; and R¹ and R³ are each independently an organic group having a fluorine atom, a hydroxyl group, an alkyl halide group, an alkoxy group, a carboxyl group, an amino group, an ester group, an amide group, a phosphazene or an aryl group at a terminal thereof.

(6) The method according to (4) or (5), wherein the perfluoropolyether compound is a perfluoropolyether compound that satisfies the following Formula (3):

$${N}_{O H} / ( Mn / 1500 ) \geq 2 \qquad ( 3 )$$

where N_{OH} represents the number of hydroxyl groups per molecule of the perfluoropolyether compound and Mn represents a number average molecular weight of the perfluoropolyether compound.

(7) A lubricant solution including a perfluoropolyether-based lubricant, the lubricant solution employing a solvent containing a hydrofluoroether having a 100-year global warming potential value of less than 1000 and having a structure represented by the following Formula (A):

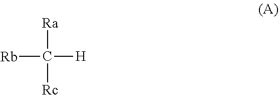

where: Ra represents F, CF₂-Re, or CF₃; Rb represents O-Rd or C(-Rf)₃; Rc represents H, F, or CF₃; Re and Rd each independently represent a hydrocarbon group which, optionally, is partially substituted by a fluorine atom and each have a main chain in which at least one carbon atom is optionally replaced by an oxygen atom; and Rfs each independently represent H, F, or a hydrocarbon group that, optionally, is partially substituted by a fluorine atom, and the hydrocarbon group that, optionally, is partially substituted by the fluorine atom has a main chain in which at least one carbon atom is optionally replaced by an oxygen atom.

### EXAMPLES

The following description will more specifically discuss the present invention on the basis of Examples; however, the present invention is not limited to the following Examples. All evaluation results are shown in Table 1 below.

### [Solvents]

The following lists solvents used for lubricant solutions in Examples and Comparative Example. Note that in Table 1, Ra, Rb, and Rc indicates Ra, Rb, and Rc in Formula (A), respectively. Further, in a case where Rb is O-Rd, Rb is referred to as “O”, and in a case where Rb is C(-Rf)₃, Rb is referred to as “C”.
Solvent 1: 1,1,2,2-tetrafluoroethyl 2,2,2-trifluoroethyl ether (CAS No. 406-78-0, manufactured by Tokyo Chemical Industry Co., Ltd.)
Solvent 2: 1,1,2,3,3,3-hexafluoropropyl methyl ether (CAS No. 382-34-3, manufactured by Tokyo Chemical Industry Co., Ltd.)
Solvent 3: 1,1,1,3,3,3-hexafluoro-2-methoxypropane (hexafluoroisopropyl methyl ether) (CAS No. 13171-18-1, manufactured by Halocarbon LLC)
Solvent 4: methyl 2,2,3,3,3-pentafluoropropyl ether (CAS No. 378-16-5, manufactured by Tokyo Chemical Industry Co., Ltd.)
Solvent 5: ethyl 1,1,2,2-tetrafluoroethyl ether (CAS No. 512-51-6, manufactured by Tokyo Chemical Industry Co., Ltd.)
Solvent 6: ethyl 1,1,2,3,3,3-hexafluoropropyl ether (CAS No. 380-34-7, manufactured by Tokyo Chemical Industry Co., Ltd.)
Solvent 7: 1,1,1,2,3,4,4,5,5,5-decafluoropentane (Vertrel-XF, manufactured by Chemours-Mitsui Fluoroproducts Co., Ltd.) Solvent 8: mixture of methyl nonafluorobutyl ether and methyl nonafluoroisobutyl ether (Novec 7100, manufactured by 3M Company)
Solvent 9: mixture of ethyl nonafluorobutyl ether and ethyl nonafluoroisobutyl ether (Novec 7200, manufactured by 3M Company).
Solvent 10: 2,2,2-trifluoroethanol (manufactured by Tosoh F-Tech Inc.).

### [Perfluoropolyether-Based Lubricant]

A perfluoropolyether compound (manufactured by MORESCO Corporation) having a structure represented by the following Formula (B):

H—(OCH₂CH(OH)CH₂)ₓ—OCH₂CF₂CF₂O—(CF₂CF₂CF₂O))ₙ—CF₂CF₂CH₂O—(CH₂CH(OH)(CH₂O)_{y}—H (B)
(n=7.2, x+y=2.2, and number average molecular weight: 1620).

### [Evaluation Methods]

The following will discuss evaluation methods for a lubricant solution and a lubricant layer prepared in each of Examples and Comparative Examples.

### (Evaluation of Solubility of Lubricant)

For each of the lubricant solutions obtained in Examples and Comparative Example, a dissolution state of a perfluoropolyether-based lubricant was visually checked. Evaluation criteria are as follows:
Good: The perfluoropolyether-based lubricant is dissolved in a solvent.
Bad: The perfluoropolyether-based lubricant has not dissolved in a solvent.

### (Measurement of Evaporability)

Evaluation of evaporability was carried out according to the following procedures (1) to (4): (1) A petri dish having a diameter of 28 mm and a depth of 15 mm was placed on an electronic balance with a draft shield, and 2 ml of a solvent was introduced into the petri dish. The petri dish was then allowed to stand still at room temperature (20° C. to 25° C. (hereinafter, the same applies to the present specification)). (2) The solvent was weighed at time points when 5 minutes, 10 minutes, 15 minutes, 20 minutes, 25 minutes, and 30 minutes elapsed after the solvent had been introduced; (3) An amount of weight loss per hour was calculated, and an average-volume reduction rate (ml/min) was calculated from the amount of weight loss calculated and a density of the solvent; (4) The average volume reduction rate in Comparative Example 1 using Vertrel-XF as the solvent was defined to be 1.0, and a relative volume reduction rate was calculated from the average-volume reduction rate which had been calculated in (3). The average-volume reduction rate of Vertrel-XF was 0.028 ml/min.

### (Measurement of Film Thickness of Lubricant-Applied Film)

The film thickness of a lubricant layer-applied film formed by applying the lubricant solution was measured according to the following procedures (1) to (3): (1) In the lubricant solution, a 2.5-inch magnetic disk was immersed for 3 minutes. Then, the magnetic disk was pulled up vertically at a rate of 1 mm/second from the solution in a manner that a pull-up direction was parallel to a surface of the magnetic disk. As a result, a lubricant layer-applied film was formed. (2) With use of an FT-IR (VERTEX 70, manufactured by Bruker Company), respective IR intensities of three points, which were a distance of 15 mm (labeled as “ID” in Table 1), a distance of 20 mm (labeled as “MD” in Table 1), and a distance of 25 mm (labeled as “OD” in Table 1) away from the center of the magnetic disk, were measured on a surface of the magnetic disk. Further, respective film thicknesses at these three points were calculated from a calibration curve between film thickness measured by an ellipsometer and IR intensity. (3) A state of the lubricant-applied film was visually checked. In a case where any abnormality such as appearance of a droplet occurred, the measurement was considered to have failed and the film thickness was assumed to be “≥14.0”.

### (Measurement of Contact Angle on Lubricant-Applied Film)

The contact angle on a lubricant-applied film was measured according to the following procedures (1) to (3): (1) In the lubricant solution, a 2.5-inch magnetic disk was immersed for 3 minutes. Then, the disk was pulled up vertically at a rate of 1 mm/second from the solution in a manner that the pull-up direction was parallel to a surface of the magnetic disk. As a result, a lubricant-applied film having a film thickness of approximately 13 Å was formed. The film thickness of the lubricant-applied film was measured by the same method as the above-described measurement, and the average value of film thicknesses measured was used as the film thickness. (2) After the magnetic disk with the lubricant-applied film formed thereon was allowed to stand still for two weeks at room temperature, 2 μL of water and 2 μL of n-hexadecane were each dropped, and the contact angle 60 seconds after dropping of water and n-hexadecane was measured with an automatic contact angle meter DM 500 (manufactured by Kyowa Interface Science Co., Ltd.). Note that in order to cause the lubricant-applied film to have a film thickness of approximately 13 Å, a concentration of the lubricant was adjusted depending on the solvent.

### (Calculation of Surface Energy)

From a contact angle θ of water with respect to the lubricant-applied film and a contact angle θ of n-hexadecane with respect to the lubricant-applied film, which have been obtained by measurement of the contact angle, a dispersed component γ^{d}, a polarized component γ^{p}, and a surface energy γ were calculated by a Kaelble-Uy method (specifically, by the following Formula):

$$γ = {γ}^{d} + {γ}^{p}$$

$$γ \text{?} ( 1 + cos θ ) = 2 \sqrt{γ \text{?} γ \text{?}} + 2 \sqrt{γ \text{?} γ \text{?}}$$

$$\text{?} \text{indicates text missing or illegible when filed}$$

In the above formula, γ_{L} represents the surface energy of a liquid, and γ_{S} represents the surface energy of a solid.

### (Evaluation of Adsorption Properties)

A magnetic disk with a lubricant-applied film prepared in a same manner as in the measurement of the contact angle was immersed in Vertrel-XF for 5 minutes. Then, the magnetic disk was pulled up vertically at a rate of 1 mm/second in a manner that the pull-up direction was parallel to a surface of the magnetic disk. Then, the magnetic disk was rinsed and the film thickness of the lubricant-applied film remaining on the magnetic disk was measured. The film thickness of the lubricant-applied film was measured with an FT-IR (manufactured by Bruker, VERTEX70).

### Example 1

The perfluoropolyether compound was dissolved, at room temperature, in the solvent 1 so as to be 1000 ppm on the mass basis. As a result, a lubricant solution was prepared. For the lubricant solution thus obtained, the solubility of a lubricant was evaluated. The evaporability was evaluated by using the solvent 1 as is.

### Examples 2 and 3

Respective lubricant solutions of Examples 2 and 3 were prepared as in Example 1 except that the solvent 1 was changed to the solvent 2 and the solvent 3, respectively. Then, the solubility of lubricants was evaluated. For the solvent 3, evaluation of the film thickness was also carried out. The evaporability was evaluated by using the solvents 2 and 3 as is.

Further, a lubricant solution was separately prepared as in Example 1 except that the perfluoropolyether compound was dissolved so as to be 500 ppm on the mass basis in the solvent 3. The lubricant solution thus separately prepared was used to form a lubricant layer-applied film. The lubricant-applied film thus obtained was subjected to evaluation of the adsorption properties, measurement of the contact angle, and calculation of the surface energy in Example 3.

### Examples 4 to 6

Respective lubricant solutions of Examples 4 to 6 were prepared as in Example 1 except that the solvent 1 was changed to solvents 4 to 6, respectively. Then, the solubility of lubricants was evaluated. The evaporability was evaluated using the solvents 4 to 6.

### Comparative Example 1

A lubricant solution of Comparative Example 1 was prepared as in Example 1 except that the solvent 1 was changed to the solvent 7. Then, the solubility and the film thickness of a lubricant were evaluated. The evaporability was evaluated using the solvent 7.

Further, a lubricant solution was separately prepared as in Example 1 except that the perfluoropolyether compound was dissolved so as to be 500 ppm on the mass basis in the solvent 7. The lubricant solution thus separately prepared was used to form a lubricant layer-applied film, and the lubricant-applied film thus obtained was subjected to measurement of the contact angle, calculation of the surface energy, and evaluation of the adsorption properties.

### Comparative Examples 2 to 4

Respective lubricant solutions of Comparative Examples 2 to 4 were prepared as in Example 1 except that the solvent 1 was changed to solvents 8 to 10, respectively. Then, the solubility and the evaporability of lubricants were evaluated. The solvent 10 (Comparative Example 4) was also subjected to measurement of the film thickness, measurement of the contact angles, calculation of the surface energy, and evaluation of the adsorption properties. The evaporability was evaluated using the solvents 8 to 10.

TABLE 1

| | | | | | | | | | | | Film thickness | | | | | |
|---|---|---|---|---|---|---|---|---|---|---|---|---|---|---|---|---|
| | | | | | | | | | | | (adsorptive | | | | | |
| | | | | | | | | | | | property | | | | | |
| | | | | | | | | Film thickness | | | evaluation) | | | | | |
| | | | | | | | | (concentration | | | [Å] | | Contact angle | | Surface | |
| | | | | | | | Evapor- | 0.1 wt %) | | | After | | [degrees] | | energy | |
| | | | | | | Solu- | ability | [Å] | | | appli- | After | | n-hexa- | [mN/m²] | |
| | Solvent | Ra | Rb | Rc | GWP | bility | [mL/min] | ID | MD | OD | cation | rinsing | H₂O | decane | γ^{p} | γ^{d} |
| Example 1 | Solvent 1 | F | C | F | 580 | Good | 0.8 | | | | | | | | | |
| | | CF₃ | O | H | | | | | | | | | | | | |
| Example 2 | Solvent 2 | F | C | CF₃ | 101 | Good | 1.0 | | | | | | | | | |
| Example 3 | Solvent 3 | CF₃ | O | CF₃ | 27 | Good | 1.1 | 17.2 | 17.5 | 17.7 | 12.9 | 8.6 | 72.5 | 64.7 | 17.5 | 14.1 |
| Example 4 | Solvent 4 | CF₂ | O | H | 11 | Good | 1.3 | | | | | | | | | |
| Example 5 | Solvent 5 | F | C | F | 557 | Good | 0.9 | | | | | | | | | |
| Example 6 | Solvent 6 | CF₃ | C | F | 23 | Good | 0.5 | | | | | | | | | |
| Comparative | Solvent 7 | CF₃ | C | F | 1,640 | Good | 1.0 | 18.3 | 18.4 | 19 | 13.0 | 8.1 | 69.6 | 64.5 | 19.5 | 14.1 |
| Example 1 | | CF₂ | C | F | | | | | | | | | | | | |
| Comparative | Solvent 8 | | | | 297 | Poor | 0.9 | | | | | | | | | |
| Example 2 | | | | | | | | | | | | | | | | |
| Comparative | Solvent 9 | | | | 59 | Poor | 0.5 | | | | | | | | | |
| Example 3 | | | | | | | | | | | | | | | | |
| Comparative | Solvent 10 | | | | 20 | Good | 0.2 | 13.3 | 13.6 | ≥14.0 | 13.4 | 5.7 | 67.7 | 64.7 | 21.0 | 14.1 |
| Example 4 | | | | | | | | | | | | | | | | |

### [Results]

As shown in Table 1, the solvents used in Examples 1 to 6 each have a GWP that is as low as less than 1000 and a small burden on global warming. Further, the solvents used in Examples 1 to 6 were each an HFE as in the cases of the solvents used in Comparative Examples 2 and 3. However, surprisingly, it was shown that the solvents dissolved a high-polarity perfluoropolyether-based lubricant. It is thus clear that the solvents used in Examples 1 to 6 each have a low GWP and an excellent solubility of a high-polarity perfluoropolyether-based lubricant in the solvent.

On the other hand, Vertrel XF of Comparative Example 1, which is currently mainly used, is excellent in the solubility of a high-polarity perfluoropolyether-based lubricant, but has a large GWP. Further, each of the HFEs that do not have a structure represented by Formula (A) and that were used in Comparative Examples 2 to 3 has a low GWP but is difficult to dissolve a high-polarity perfluoropolyether-based lubricant.

Furthermore, the solvents used in Examples 1 to 6 each had an evaporability in a range of 1.0±0.5 with respect to that of Vertrel XF of Comparative Example 1 which is currently mainly used. Since these solvents evaporate very quickly, the solvents each can be used as a solvent for the lubricant solution without any problem. On the other hand, it was found that in the case of the solvent of Comparative Example 4 which was not an HFE, the evaporability was 0.2, and the evaporation rate was slower when compared with those of Examples 1 to 6 and Comparative Example 1.

Further, in Example 3, the lubricant layer-applied film, which had been formed, had a small variation between the film thicknesses at the three points from the center of the magnetic disk to an outer side of the magnetic disk. The variation was shown to be comparable with that in the case of using Vertrel XF in Comparative Example 1. On the other hand, in Comparative Example 4 in which a solvent other than an HFE was used, generation of a droplet(s) was observed on an outer side (OD) of the magnetic disk, and the film thickness could not be measured. For this reason, Comparative Example 4 cannot be used as the lubricant solution. Note that there is a correlation between the evaporability and the variation in film thickness. When the evaporability is high, the solution attached to the disk pulled up from the lubricant solution immediately evaporates. Accordingly, since the lubricant liquid solution does not flow down and accumulate in a lower part of the disk, the film thickness becomes uniform. In each of Examples 1, 2, and 4 to 6, the variation in film thickness at the three points from the center toward the outer side of the magnetic disk was not measured. However, since the evaporability of each of Examples 1, 2, and 4 to 6 is comparable with that of Example 3, results in these Examples are predicted to be similar to that of Example 3.

Further, in evaluation of the adsorption properties, in Example 3, a change in film thickness before and after rinsing was smaller than those in Comparative Examples 1 and 4. That is, the lubricant layer formed in Example 3 was indicated to have high adsorption properties with respect to the magnetic disk. Further, Example 3 showed that the contact angle with water particularly was higher and the surface energy was lower than those of Comparative Examples 1 and 4. In other words, it has been clarified that the lubricant layer formed in Example 3 can prevent better prevention of contamination of the surface of the magnetic disk.

### INDUSTRIAL APPLICABILITY

A method for producing a magnetic disk in accordance with an embodiment of the present invention and a lubricant solution in accordance with an embodiment of the present invention make it possible to achieve: a method for producing a magnetic disk that employs a fluorine-based solvent which has a low GWP and in which solubility of a high-polarity perfluoropolyether-based lubricant is excellent; and a lubricant solution that employs the fluorine-based solvent. Therefore, the method and the lubricant can be advantageously used in production of magnetic disks.

Further, an HFE used for the method for producing a magnetic disk in accordance with an embodiment of the present invention and for the lubricant solution in accordance with an embodiment of the present invention has a low GWP and a small burden on the Earth. Use of a solvent having a low GWP in an entire HDD industry can minimize a negative impact on global warming. This can contribute to achieving Goal 13 “Take urgent action to combat climate change and its impacts” of the Sustainable Development Goals (SDGs).

### REFERENCE SIGNS LIST

1 magnetic disk
2 lubricant layer
3 protective layer
4 recording layer
5 lower layer
6 soft magnetic lower layer
7 adhesive layer
8 non-magnetic substrate

1. A method for producing a magnetic disk, the method comprising a lubricant application step of applying, to a surface of a magnetic disk, a lubricant solution containing a perfluoropolyether-based lubricant, the lubricant solution employing a solvent containing a hydrofluoroether having a 100-year global warming potential value of less than 1000 and having a structure represented by the following Formula (A): 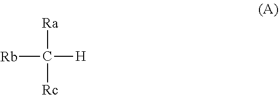
where: Ra represents F, CF₂-Re, or CF₃; Rb represents O-Rd or C(-Rf)₃; Rc represents H, F, or CF₃; Re and Rd each independently represent a hydrocarbon group which, optionally, is partially substituted by a fluorine atom and each have a main chain in which at least one carbon atom is optionally replaced by an oxygen atom; and Rfs each independently represent H, F, or a hydrocarbon group that, optionally, is partially substituted by a fluorine atom, and the hydrocarbon group that, optionally, is partially substituted by the fluorine atom has a main chain in which at least one carbon atom is optionally replaced by an oxygen atom,
the hydrofluoroether being contained in an amount of more than 70% by weight relative to a total amount of the solvent,
the perfluoropolyether-based lubricant including a perfluoropolyether compound that satisfies the following Formula (3):
$${N}_{O H} / ( Mn / 1500 ) \geq 2 , \qquad ( 3 )$$
where N_{OH} represents the number of hydroxyl groups per molecule of the perfluoropolyether compound and Mn represents a number average molecular weight of the perfluoropolyether compound.

2. The method according to claim 1, wherein the solvent has a boiling point of 30° C. to 100° C. and is flame-resistant.

3. The method according to claim 1, wherein the hydrofluoroether has three or more carbon-hydrogen bonds.

4. The method according to claim 1, wherein the perfluoropolyether-based lubricant contains a perfluoropolyether compound having a structure represented by the following Formula (1):
—(CF₂)ₓ(CF(CF₃))_{y}O(CF₂O)_{z}(CF₂CF₂O)ₗ(CF₂CF₂CF₂O)ₘ(CF₂CF₂CF₂CF₂O)ₙ(CF(CF₃)CF₂O)ₒ—(CF(CF₃))_{y}(CF₂)ₓ— (1),
where x is a real number of 0 to 3, y is a real number of 0 to 1, and z, l, m, n, and o are each a real number of 0 to 15 and further, either x or y is a real number of 1 or more and at least any one of z, l, m, n, and o is a real number of 1 or more.

5. The method according to claim 1, wherein the perfluoropolyether-based lubricant is a perfluoropolyether compound having a structure represented by the following Formula (2):
R¹—R²—R³ (2),
where: R² is an organic group having a perfluoropolyether skeleton; and R¹ and R³ are each independently an organic group having a fluorine atom, a hydroxyl group, an alkyl halide group, an alkoxy group, a carboxyl group, an amino group, an ester group, an amide group, a phosphazene or an aryl group at a terminal thereof.

6. (canceled)

7. A lubricant solution comprising a perfluoropolyether-based lubricant, the lubricant solution employing a solvent containing a hydrofluoroether having a 100-year global warming potential value of less than 1000 and having a structure represented by the following Formula (A): 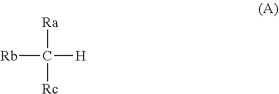
where: Ra represents F, CF₂-Re, or CF₃; Rb represents O-Rd or C(-Rf)₃; Rc represents H, F, or CF₃; Re and Rd each independently represent a hydrocarbon group which, optionally, is partially substituted by a fluorine atom and each have a main chain in which at least one carbon atom is optionally replaced by an oxygen atom; and Rfs each independently represent H, F, or a hydrocarbon group that, optionally, is partially substituted by a fluorine atom, and the hydrocarbon group that, optionally, is partially substituted by the fluorine atom has a main chain in which at least one carbon atom is optionally replaced by an oxygen atom,
the hydrofluoroether being contained in an amount of more than 70% by weight relative to a total amount of the solvent,
the perfluoropolyether-based lubricant including a perfluoropolyether compound that satisfies the following Formula (3):
$${N}_{O H} / ( Mn / 1500 ) \geq 2 , \qquad ( 3 )$$
where N_{OH} represents the number of hydroxyl groups per molecule of the perfluoropolyether compound and Mn represents a number average molecular weight of the perfluoropolyether compound.

8. A method for producing a magnetic disk, the method comprising a lubricant application step of applying, to a surface of a magnetic disk, a lubricant solution containing a perfluoropolyether-based lubricant, the lubricant solution employing a solvent containing a hydrofluoroether excluding 1,1,1,3,3,3-hexafluoroisopropyl methyl ether, 1,1,2,2-tetrafluoroethyl 2,2,2-trifluoroethyl ether, and 1,1,2,3,3,3-hexafluoropropyl methyl ether, the hydrofluoroether having a 100-year global warming potential value of less than 1000 and having a structure represented by the following Formula (A): 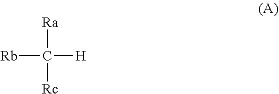
where: Ra represents F, CF₂-Re, or CF₃; Rb represents O-Rd or C(-Rf)₃; Rc represents H, F, or CF₃; Re and Rd each independently represent a hydrocarbon group which, optionally, is partially substituted by a fluorine atom and each have a main chain in which at least one carbon atom is optionally replaced by an oxygen atom; and Rfs each independently represent H, F, or a hydrocarbon group that, optionally, is partially substituted by a fluorine atom, and the hydrocarbon group that, optionally, is partially substituted by the fluorine atom has a main chain in which at least one carbon atom is optionally replaced by an oxygen atom.

9. The method according to claim 8, wherein the hydrofluoroether having the structure represented by the Formula (A),
where: Ra represents F, CF₂-Re, or CF₃; Rb represents O-Rd or C(-Rf)₃; Rc represents H or F; Re represents a hydrocarbon group which, optionally, is partially substituted by a fluorine atom, and has a main chain in which at least one carbon atom is optionally replaced by an oxygen atom; Rd is a hydrocarbon; and Rfs each independently represent OCH₂CH₃ or F.

10. The method according to claim 8, wherein the perfluoropolyether-based lubricant includes a perfluoropolyether compound that satisfies the following Formula (3):
$${N}_{O H} / ( Mn / 1500 ) \geq 2 , \qquad ( 3 )$$
where N_{OH} represents the number of hydroxyl groups per molecule of the perfluoropolyether compound and Mn represents a number average molecular weight of the perfluoropolyether compound.

11. (canceled)

12. (canceled)

13. The method according to claim 8, wherein the solvent has a boiling point of 30° C. to 100° C. and is flame-resistant.

14. The method according to claim 8, wherein the hydrofluoroether has three or more carbon-hydrogen bonds.

15. The method according to claim 8, wherein the perfluoropolyether-based lubricant contains a perfluoropolyether compound having a structure represented by the following Formula (1):
—(CF2)x(CF(CF3))yO(CF2O)z(CF2CF2O)l(CF2CF2CF2O)m(CF2CF2CF2CF2O)n(CF(CF3)CF2O)o-(CF(CF3))y(CF2)x- (1),
where x is a real number of 0 to 3, y is a real number of 0 to 1, and z, l, m, n, and o are each a real number of 0 to 15 and further, either x or y is a real number of 1 or more and at least any one of z, l, m, n, and o is a real number of 1 or more.

16. The method according to claim 8, wherein the perfluoropolyether-based lubricant is a perfluoropolyether compound having a structure represented by the following Formula (2):
R1-R2-R3 (2),
where: R2 is an organic group having a perfluoropolyether skeleton; and R1 and R3 are each independently an organic group having a fluorine atom, a hydroxyl group, an alkyl halide group, an alkoxy group, a carboxyl group, an amino group, an ester group, an amide group, a phosphazene or an aryl group at a terminal thereof.

17. The lubricant solution according to claim 7, wherein the solvent has a boiling point of 30° C. to 100° C. and is flame-resistant.

18. The lubricant solution according to claim 7, wherein the hydrofluoroether has three or more carbon-hydrogen bonds.

19. The lubricant solution according to claim 7, wherein the perfluoropolyether-based lubricant contains a perfluoropolyether compound having a structure represented by the following Formula (1):
—(CF2)ₓ(CF(CF3))yO(CF2O)z(CF2CF2O)l(CF2CF2CF2O)m(CF2CF2CF2CF2O)n(CF(CF3)CF2O)o-(CF(CF3))y(CF2)x- (1),
where x is a real number of 0 to 3, y is a real number of 0 to 1, and z, l, m, n, and o are each a real number of 0 to 15 and further, either x or y is a real number of 1 or more and at least any one of z, l, m, n, and o is a real number of 1 or more.

20. The lubricant solution according to claim 7, wherein the perfluoropolyether-based lubricant is a perfluoropolyether compound having a structure represented by the following Formula (2):
R1-R2-R3 (2),
where: R2 is an organic group having a perfluoropolyether skeleton; and R1 and R3 are each independently an organic group having a fluorine atom, a hydroxyl group, an alkyl halide group, an alkoxy group, a carboxyl group, an amino group, an ester group, an amide group, a phosphazene or an aryl group at a terminal thereof.
